(19) United States
(12) Patent Application Publication
(10) Pub. No.: US 2006/0059527 A1
(43) Pub. Date: Mar. 16, 2006

(54) Set top box having tv plaza function and method for applying tv plaza function to the set top box

(75) Inventor: Seung-Lim Jee, Seocho-gu (KR)

Correspondence Address: HOFFMANN & BARON, LLP, 6900 JERICHO TURNPIKE, SYOSSET, NY, 11791, US

(73) Assignee: ALTICAST CORP, Seoul (KR)

(21) Appl. No.: 10/529,672

(22) PCT Filed: Sep. 29, 2003
(86) PCT No.: PCT/KR03/01988

§ 371 Date: Mar. 29, 2005

(30) Foreign Application Priority Data
Oct. 1, 2002 (KR) 10-2002-0059977

(51) Int. Cl. H04N 7/173; H04N 7/16

(52) U.S. Cl. 725/100; 725/131; 725/139

(57) ABSTRACT

The present invention relates to a set top box having TV plaza function and a method for applying TV plaza function to the set top box. The set top box according to the present invention comprises: a) a signal input interface which receives a TV plaza information signal as well as a broadcast signal; b) a DEMUX which classifies and separates the TV Plaza information signal from the broadcast signal; c) a signal output interface connected to a user's TV, which decodes the TV plaza information signal as well as the broadcast signal and transmits the decoded signals to the user's TV; d) a microprocessor which generates a command to control the set top box; and e) a storage device which stores the TV plaza information signal, wherein the TV plaza information signal is firstly stored into the storage device independently of a user's request and the previously stored TV plaza information is transmitted under control of the microprocessor to the user's TV through the DEMUX and the signal output interface in response to the user's request.

### TECHNICAL FIELD OF THE INVENTION

The present invention relates to a set top box having TV plaza function and a method for applying TV plaza function to the set top box.

### BRIEF DESCRIPTION OF THE DRAWINGS

FIG. 1 schematically illustrates the basic structure of the conventional set top box, and the flow of a broadcast signal.

FIG. 2 schematically illustrates a specific exemplary embodiment of the conventional set top box shown in FIG. 1, and the flow of a broadcast signal.

FIG. 3 schematically illustrates a set top box having TV plaza function in accordance with an embodiment of the present invention.

FIG. 4 schematically illustrates a specific embodiment of the set top box shown in FIG. 3.

FIG. 5 is another preferred embodiment of a set top box having TV plaza function in accordance with the present invention.

### BACKGROUND OF THE INVENTION

Interactive televisions have been tested and developed by various satellite broadcasting providers, telephone providers and/or cable television providers. The interactive televisions enable users to actively interact with the televisions beyond simple channel manipulation, simple tone control, simple videotape recoding, etc. For this reason, the potential of the interactive televisions is very high. For example, the users of the interactive televisions can make an access to videos on demand, payments of bills, banking and shopping, and participate in forums.

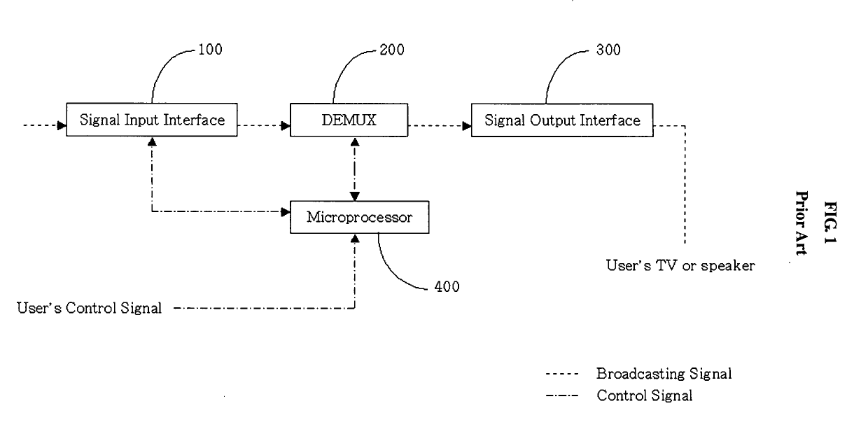

Various set top boxes which are required for adapting the conventional television sets to interactive televisions have been developed. FIG. 1 schematically illustrates the basic structure of one of the conventional set top boxes. As shown in FIG. 1, the conventional set top box comprises a signal input interface 100 which receives a broadcast signal, a demultiplexer (DEMUX) 200 which classifies the received broadcast signal, a signal output interface 300 which decodes the received broadcast signal and transmits the decoded broadcast signal to a user's display device, and a microprocessor 400 which generates a command in response to user's control signal.

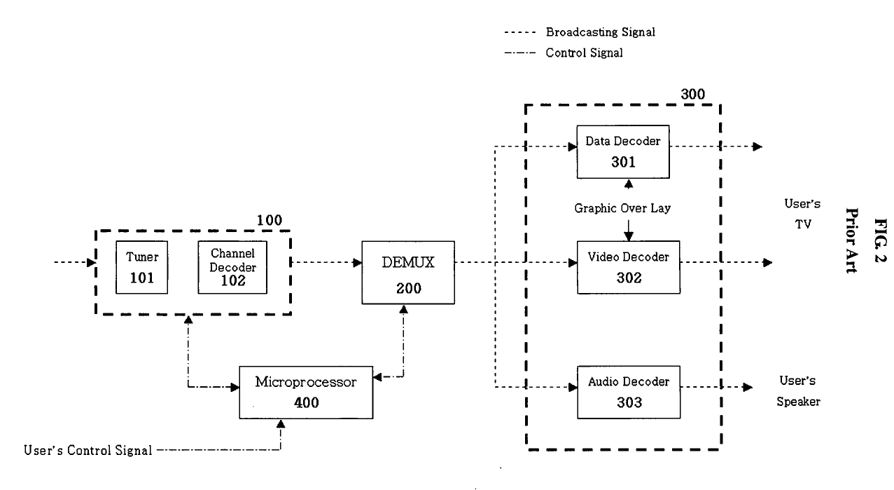

FIG. 2 schematically illustrates an exemplary embodiment of the processing of a broadcast signal by the conventional set top box shown in FIG. 1, wherein a signal input interface 100 comprises a tuner 101 which receives an encoded broadcast signal and a channel decoder 102 which extracts a user-requested channel from the received broadcast signal under control of a microprocessor 400. The broadcast signal encoded under a suitable compression standard can be one of a video signal, an audio signal, a data signal for data broadcast or a composite signal thereof. The broadcast signal is classified by the action of a DEMUX 200 and then is transmitted to a signal output interface 300. Relied upon the forms of the broadcast signal, the signal output interface 300 comprises at least one decoder selected from the group consisting of a data decoder 301 which decodes the data signal, a video decoder 302 which decodes the video signal, and an audio decoder 303 which decodes the audio signal. For example, the DEMUX 200 extracts an audio signal from the user-requested channel and then transmits it to the audio decoder 303 which decodes the delivered audio signal and transmits the decoded signal to a user's speaker in an analog form.

Likewise, a video signal is decoded by the video decoder 302 of the signal output interface 300 and is then transmitted to a user's TV. If the user's TV is analog type, the decoded video signal is transmitted to the user's TV in an encoded form by one of various standard video formats, for example, NTSC (National Television Standard Committee), RGB (Red-Green-Blue) and PAL (Phase Alternation by Line). In case that the broadcast signal is a composite signal, for example, of the data signal and the video signal, the data and video signals are separated each other from the composite signal by the action of the DEMUX 200 and is transmitted to the data decoder 301 and the video decoder 302, respectively. If matching of the decoded data and video signals is required, the matching is performed through graphic over lay technology. The matched signal is then transmitted to the user's TV.

The conventional set top box described in FIG. 1 or 2, however, has not been popularly used, because the set top box is an expensive one and various additional functions are not currently available. The cost for the set top box amounts to about 200-250$ and broadcasting providers and users should take the entire burden. Therefore, there is a need to provide new set top box having new additional functions that satisfy all of the service providers, the end users and broadcasting providers, and which apportion the high burden of the set top box to various persons, besides the broadcasting providers and the users.

### SUMMARY OF THE INVENTION

The object of the present invention is to provide a set top box having TV plaza function.

Another object of the present invention is to provide a set top box having TV plaza function, wherein the set top box enables service providers to make data accumulation and data correction, users to make data navigation, and the providers and the users to make data communications with each other.

The other object of the present invention is to provide a method of applying TV plaza function to a set top box.

The above objects and other objects which will be described in the detailed description of the present invention can be achieved by provision of a set top box comprising: a) a signal input interface which receives a TV plaza information signal as well as a broadcast signal; b) a DEMUX which classifies and separates the TV Plaza information signal from the broadcast signal; c) a signal output interface connected to a user's TV, which decodes the TV plaza information signal as well as the broadcast signal and transmits the decoded signals to the user's TV; d) a microprocessor which generates a command to control the set top box; and e) a storage device which stores the TV plaza information signal, wherein the TV plaza information signal is firstly stored into the storage device independently of a user's request and the previously stored TV plaza information is transmitted under control of the microprocessor to the user's TV through the DEMUX and the signal output interface in response to the user's request.

### DETAILED DESCRIPTION OF THE INVENTION

As used herein, the phrase “TV plaza” (television plaza) refers to a plaza formed within a set top box, wherein the plaza is formed by storing information data supplied from various information providers other than a TV user (or viewer) into a storage device of the set top box independently of the TV user (or viewer), and the user searches and displays the information data previously stored within the set top box onto the user's TV. That is, TV plaza refers to a plaza of the information data stored independently of the user's request into a storage device of the set top box and the user can browse or navigate the user-independently stored information and displays the user-requested information.

The phrase “TV plaza information”, as used herein, refers to information supplied for the construction of TV plaza. The storage and the correction of the TV plaza information are independent of a user's request or demand, while the navigation and the display of the information are dependent upon the user's request. Such TV plaza information may be life information including advertisement information (for example goods information and company information), education information, stock information and weather information. Further, the phrase “a TV plaza information signal” refers to a signal produced from suitable digital encoding of TV plaza information such that a set top box can receive the signal. The TV plaza information signal is characterized in that the information signal is independent of the ordinary broadcast signal and is stored independently of the user's request into a storage device such as hard disk assigned to store the information signal, thereby constructing TV plaza within the set top box of the user.

The phrase “a broadcast signal”, as used herein, refers to a signal in which a user can determine both the storage of the broadcast signal and the display thereof. Such a broadcast signal includes, but is not limited to, ordinary signals supplied by television broadcasting provider such as KBS, MBC, SBS, CNN and NHK, satellite broadcasting providers and CATV broadcasting providers.

While providers for the TV plaza information signal can be different from those for the broadcast signal, preferably the TV plaza information signal and the broadcast signal are provided by the same providers. But, it should be understood that TV plaza information signal and the broadcast signal are provided in a separated form. The phrase “a separated form” means that the TV plaza information signal has different identification information from that of the broadcast signal.

The phrase “a TV plaza operator”, as used herein, refers to a person who operates and manages TV plaza as a whole. Further, “a TV plaza subscriber” refers to a person who provides TV plaza information under the agreement with the TV plaza operator. As a TV plaza subscriber, the persons who intend to advertise goods, to inform companies and/or services can be mentioned.

In the following, the present invention will be more fully illustrated referring to the attached drawings.

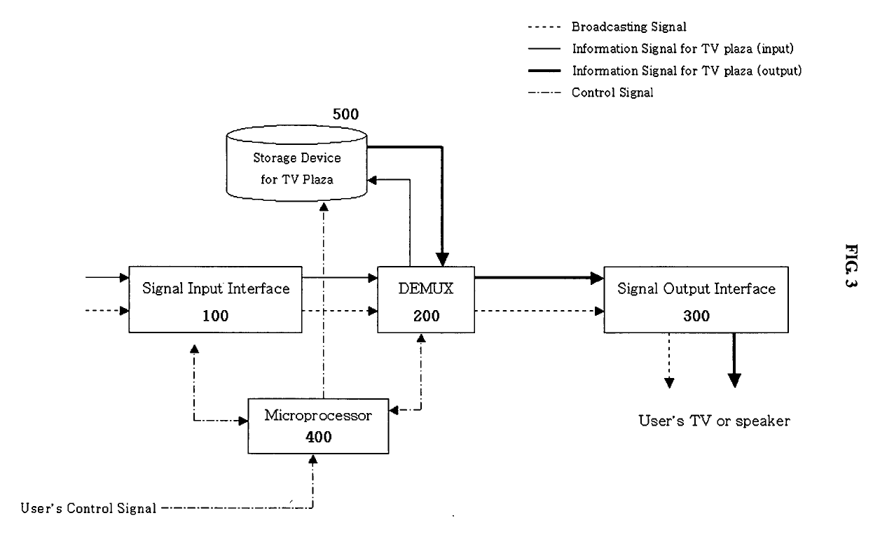

FIG. 3 schematically illustrates a set top box having TV plaza function in accordance with an embodiment of the present invention. As shown in FIG. 3, the set top box comprises: a) a signal input interface 100 which receives a TV plaza information signal as well as a broadcast signal; b) a DEMUX 200 which classifies and separates the TV Plaza information signal from the broadcast signal; c) a signal output interface 300 connected to a user's TV, which decodes the TV plaza information signal as well as the broadcast signal and transmits the decoded signals to the user's TV; d) a microprocessor 400 which generates a command to control the set top box; and e) a storage device 500 which stores the TV plaza information signal, wherein the TV plaza information signal is stored into the storage device 500 independently of a user's request and, in response to the user's control signal, the previously stored information signal is transmitted under control of the microprocessor 400 to the user's TV through the DEMUX 200 and the signal output interface 300.

Specifically, the TV plaza information signal and the broadcast signal, which are preferably digitally compressed by one of various compression standards (for example, MPEG standard), are firstly transmitted to the signal input interface 100. The broadcast signal of the two signals is processed in a conventional manner. That is, the broadcast signal is transmitted to the signal output interface 300 through the DEMUX 200 under control of the microprocessor 400, and there, decoding of the broadcast signal is performed. The decoded broadcast signal is then transmitted and displayed onto a user's display device (TV or speaker).

In case that the received signal is a TV plaza information signal, the signal is firstly identified by the DEMUX 200, and then is stored independently of the user's control signal into a storage device 500 to form a TV plaza within the set top box of the user. If the user wants to display some of the information directed to a particular article from the TV plaza, he generates a control signal, for example, by the manipulation of a remote controller. Such a request is transmitted to the microprocessor 400 and the requested information is transmitted to the signal output interface 300 via the DEMUX 200 under control of the microprocessor 400. By the signal output interface 300, the requested information is decoded into a suitable format to be displayed and transmitted to a user's display device (TV or speaker).

Besides storage of the TV plaza information signal into the storage device 500, which is called as “data accumulation, the stored data can be update by transmitting the revised information to the signal input interface 100, wherein the identification of the revised information is performed by the DEMUX 200. Further, the incorrect information can be also corrected. These processes, called as “data correction”, would be readily understood to a person of ordinary skill to which the present invention pertains.

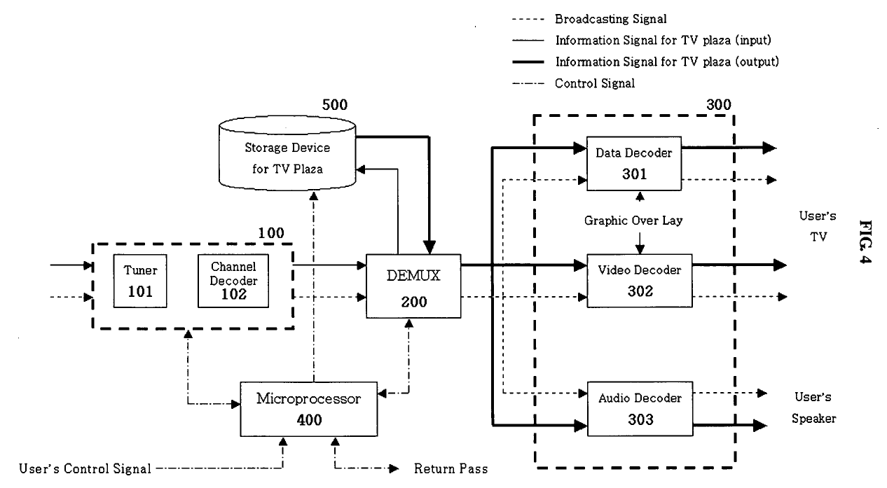

FIG. 4 schematically illustrates a specific example of the set top box shown in FIG. 3. As shown in FIG. 4, a signal input interface 100 preferably comprises a tuner 101 which receives a TV plaza information signal as well as a broadcast signal and a channel decoder 102 which extracts a user-requested channel from the received broadcast signal under control of a microprocessor 400. According to the preferred embodiment of the present invention, the channel decoder 102 can be installed within the tuner 101. The received broadcast signal is separated by the action of a DEMUX 200 into a data signal, a video signal, and an audio signal. The separated signals are transmitted to a signal output interface 300, and there, a data decoder 301, a video decoder 302 and an audio decoder 303 decodes them respectively. After that, the decoded data and video signals are transmitted to a user's TV, and the decoded audio signal is transmitted to a user's speaker. If required, a digital video recorder or a personal video recorder can be installed in order to store the broadcast signal under control of the microprocessor 400 in response to a user's request.

Meanwhile, the TV plaza information signal is stored independently of the user's request into a storage device 500 via the DEMUX 200, and constructs a TV plaza within the set top box of the user. When a user's request to display certain information from the TV plaza is detected by the microprocessor 400, the requested information is transmitted to the DEMUX 200 and is separated into a data signal, a video signal and an audio signal by the action of the DEMUX 200. The separated signals are transmitted to the signal output interface 300, and there, the data decoder 301, the video decoder 302 and the audio decoder 303 decodes them respectively. After that, the decoded data and video signals are transmitted to a user's TV, and the decoded audio signal is transmitted to a user's speaker. In a case that matching of the decoded data signal with the decoded video signal is required, the matching is performed through graphic over lay technology. The matched signal is then transmitted to the user's TV. Further, if the user's TV is a analog type, the decoded and matched signal is transmitted to the user's TV in an encoded form by one of various standard video formats, for example, NTSC (National Television Standard Committee), RGB (Red-Green-Blue) and PAL (Phase Alternation by Line).

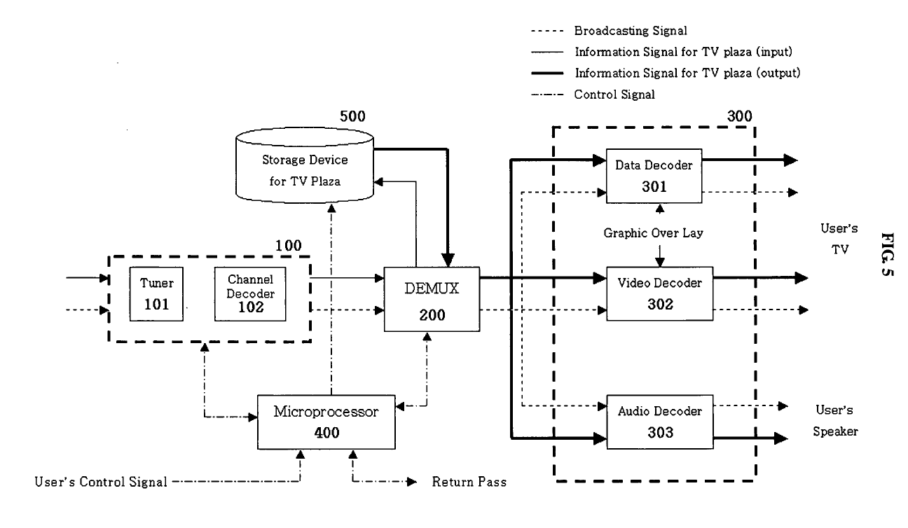

The set top box having TV plaza function according to the present invention may have additional functions that give various additional services to the user. For example, a function for data communication between the user and the TV plaza operator (or TV plaza subscriber) can be added to the set top box of the present invention. Such an example is described in FIG. 5. As shown in FIG. 5, the set top box of the present invention can further comprise a cryptographic module 600 such as a Certificate Authority System (CAS) module such that user identification information can be transmitted to the TV plaza subscriber, directly or through the TV plaza operator.

In a case that acknowledgement of the receipt of the TV plaza information is required, the set top box having TV plaza function according to the present invention can further comprise a software module (agent for the management and report of TV plaza information stored in the storage device) so that a return path can be made to the server of a TV plaza operator. For example, when the safe receipt and the storage of a certain TV plaza information is detected by the DEMUX 200 and/or the microprocessor 400, the software module can notify, under the control of the microprocessor, the server that the TV plaza information is safely received and stored within the set top box. Such a return path enables the TV plaza operator to control and manage the TV plaza information in a systemic manner.

The present invention also relates to a method for applying TV plaza function to a set top box, comprising:
i) providing a set top box composed of: a) a signal input interface which receives a TV plaza information signal as well as a broadcast signal; b) a DEMUX which classifies and separates the TV Plaza information signal from the broadcast signal; c) a signal output interface connected to a user's TV, which decodes the TV plaza information signal as well as the broadcast signal and transmits the decoded signals to the user's TV; d) a microprocessor which generates a command to control the set top box; and e) a storage device which stores the TV plaza information signal;
ii) transmitting to the signal input interface the TV plaza information and the broadcast signal, each independently;
iii) transmitting the broadcast signal of the two signals to a user's TV under control of the microprocessor, the broadcast signal being separated from the TV plaza information signal by the action of the DEMUX and decoded by the signal output interface;
iv) storing independently of a user's request the TV plaza information signal separated from the broadcast signal by the action of the DEMUX into the storage device, and constructing a TV plaza within the set top box; and,
v) under control of the microprocessor in response to a user's request to display the previously stored TV plaza information, transmitting the TV plaza information signal to a user's TV through the DEMUX and the signal output interface which decodes the TV plaza information signal.

More specifically, a TV plaza information signal and a broadcast signal, which are preferably digitally encoded by various compression standards (for example, MPEG standard), are transmitted to a signal input interface. And then, the signals are transmitted to a DEMUX, which separates the two signals into each other. The broadcast signal separated from the TV plaza information is then transmitted to a signal output interface, and there, decoding of the signal is performed. The decoded broadcast signal is then displayed onto a user's TV. To the contrary, the TV plaza information signal separated from the broadcast signal by the action of the DEMUX is transmitted and stored into a storage device independently of a user's request, and constructs a TV plaza within the set top box. In response to a user's request to display a certain information from the TV plaza, the requested information is transmitted to the signal output interface through the DEMUX under control of the microprocessor, and there, decoding of the requested information is performed. After that, the decoded information is displayed onto a user's TV. Meanwhile, if the broadcast signal and/or the TV plaza information signal is a composite signal selected from the group consisting of a data signal, a video signal and an audio signal, the DEMUX separates the signals into each other and the separated signals are decoded by a data decoder, a video decoder and an audio decoder, respectively, as described in the above.

Further, the method of the present invention may send a return path massage from a software module to the server managed by a TV plaza operator, when the TV plaza information is safely received and stored into the storage device. The method may also further comprise an ordering step using a cryptographic module.

The set top box having a TV plaza function according to the present invention makes it possible to quickly access to the information supplied from the TV plaza subscriber. In other words, the TV plaza information stored within the set top box can be quickly displayed onto a user's TV. The user may save the time to obtain the necessary information, because the information is stored within the user's set top box. The user can contact with the necessary information within about 2-3 seconds by simple manipulation of a remote controller. To the contrary, it takes about 40-60 seconds to obtain the information with a personal computer (PC). Further, the procedures required for obtaining the information, PC power on, access to the internet, migration to web site containing the necessary information, are not intimate works for the older such that these procedures may cause troublesome problems.

Further, the set top box having TV plaza function and a method for applying TV plaza function to the set top box in accordance with the present invention provides another advantage that the TV plaza subscribers can independently construct TV plazas within the set top boxes of users such that they may have their own plazas such as an shopping mall within the set top boxes. And, the users can contact and display the various information stored within the set top boxes onto the user's TV by simple manipulation of a remote controller. That is, the set top box having TV plaza function and a method for applying TV plaza function to the set top box enables TV plaza subscribers (or TV plaza operators) to construct their own plazas within the user's set top boxes independently of the users, and the users can freely contact with the information stored within the set top boxes. Therefore, the users and the TV plaza subscribers (or TV plaza operator) can enjoy their own privileges, that is, the construction of the TV plaza (data accumulation and data correction) is controlled by the TV plaza subscribers, and the navigation of the information is by the users. For example, when the memory assigned to store the TV plaza information is 20 Gbytes in which 10 Gbytes are assigned for a subscriber who sells clothes and the other 10 Gbytes are for a subscriber who provides stock information, the subscribers can construct, independently of users, malls for notifying the users of the clothes information and of the stock information, and the users can freely obtain the clothes information and the stock information from the TV plaza. Preferably, the TV plaza contains various pools of the information in order to satisfy the user's various demands.

The set top box having TV plaza function and a method for applying TV plaza function to the set top box in accordance with the present invention also enable the users to have active contacts with the TV plaza information, compared with the conventional TV that that enables the users to have passive contacts with the information.

Further, the set top box having TV plaza function and a method for applying TV plaza function to the set top box in accordance with the present invention contribute to the popularization of the set top box. Specifically, the cost for the conventional set top box was a burden to broadcasting providers and users, up to now. For the set top box having TV plaza function, however, the burden can be apportioned to a TV plaza operator, TV plaza subscribers (for example, products providers and information providers) as well as the broadcasting providers and the users. For this reason, the cost apportioned to the users will be reduced, which contributes to the popularization of the set top box.

1. A set top box comprising:
a) a signal input interface which receives a TV plaza information signal as well as a broadcast signal;
b) a DEMUX which classifies and separates the TV Plaza information signal from the broadcast signal;
c) a signal output interface connected to a user's TV, which decodes the TV plaza information signal as well as the broadcast signal and transmits the decoded signals to the user's TV;
d) a microprocessor which generates a command to control the set top box; and,
e) a storage device which stores the TV plaza information signal, wherein the TV plaza information signal is firstly stored into the storage device independently of a user's request and the previously stored TV plaza information is transmitted under control of the microprocessor to the user's TV through the DEMUX and the signal output interface in response to the user's request.

2. The set top box as set forth in claim 1, wherein the signal input interface comprises a tuner which receives the TV plaza information signal as well as the broadcast signal and a channel decoder which extracts a user-requested channel from the received broadcast signal under control of a microprocessor.

3. The set top box as set forth in claim 1, wherein the signal output interface comprises at least one decoder selected from the group consisting of a data decoder, a video decoder and an audio decoder.

4. The set top box as set forth in claim 1, wherein the TV plaza information signal is a digitally encoded information signal, and the TV plaza information is life information including advertisement information, education information, stock information and weather information.

5. The set top box as set forth in claim 3, wherein the TV plaza information signal is a composite signal selected from the group consisting of a data signal, a video signal and an audio signal, and the DEMUX separates the composite signal and transmits the separated signals to the corresponding decoders.

6. The set top box as set forth in claim 1, further comprising a cryptographic module.

7. The set top box as set forth in claim 1, further comprising a software module to send a return path massage to a server managed by a TV plaza operator, when the TV plaza information is safely received and stored into the storage device.

8. A method for providing TV plaza function to a set top box, comprising:
i) providing a set top box composed of: a) a signal input interface which receives a TV plaza information signal as well as a broadcast signal; b) a DEMUX which classifies and separates the TV Plaza information signal from the broadcast signal; c) a signal output interface connected to a user's TV, which decodes the TV plaza information signal as well as the broadcast signal and transmits the decoded signals to the user's TV; d) a microprocessor which generates a command to control the set top box; and e) a storage device which stores the TV plaza information signal;
ii) transmitting to the signal input interface the TV plaza information and the broadcast signal, each independently;
iii) transmitting the broadcast signal of the two signals to a user's TV under control of the microprocessor, the broadcast signal being separated from the TV plaza information signal by the action of the DEMUX and decoded by the signal output interface;
iv) storing independently of a user's request the TV plaza information signal separated from the broadcast signal by the action of the DEMUX into the storage device, and constructing a TV plaza within the set top box; and,
v) under control of the microprocessor in response to a user's request to display the previously stored TV plaza information, transmitting the TV plaza information signal to a user's TV through the DEMUX and the signal output interface which decodes the TV plaza information signal.

9. The method as set forth in claim 8, wherein the signal input interface comprises a tuner which receives the TV plaza information signal as well as the broadcast signal and a channel decoder which extracts a user-requested channel from the received broadcast signal under control of a microprocessor.

10. The method as set forth in claim 8, wherein the signal output interface comprises at least one decoder selected from the group consisting of a data decoder, a video decoder and an audio decoder.

11. The method as set forth in claim 8, wherein the TV plaza information signal is a digitally encoded information signal, and the TV plaza information is life information including advertisement information, education information, stock information and weather information.

12. The method as set forth in claim 10, wherein the TV plaza information signal is a composite signal selected from the group consisting of a data signal, a video signal and an audio signal, and the DEMUX separates the composite signal and transmits the separated signals to the corresponding decoders.

13. The method as set forth in claim 8, wherein the set top box further comprises a cryptographic module and the method further comprises a step of ordering an article to be purchased with the cryptographic module.

14. The method as set forth in claim 8, wherein the set top box further comprises a software module and the method further comprises a step of sending a return path massage to a server managed by a TV plaza operator, when the TV plaza information is safely received and stored into the storage device with the software module.
